(19) United States
(12) Patent Application Publication
(10) Pub. No.: US 2024/0356000 A1
(43) Pub. Date: Oct. 24, 2024

(54) LAMINATION OF MULTIPLE THIN LITHIUM STRIPS ONTO CURRENT COLLECTOR LAYER TO FORM A WIDER LITHIUM METAL ANODE

(71) Applicant: GM GLOBAL TECHNOLOGY OPERATIONS LLC, Detroit, MI (US)

(72) Inventors: Erik Damon HUEMILLER, Troy, MI (US); Wayne CAI, Troy, MI (US); Ryan GLYNN, Royal Oak, MI (US); Wai Ping Gloria TAM, Troy, MI (US); Jennifer Therese BRACEY, Holly, MI (US)

(21) Appl. No.: 18/303,675

(22) Filed: Apr. 20, 2023

(51) Int. Cl. H01M 4/04; H01M 4/1395

(52) U.S. Cl. CPC H01M 4/0435; H01M 4/1395

(57) ABSTRACT

A method for manufacturing an anode electrode includes providing a current collector layer on a rolling surface; arranging N strips of lithium metal parallel to one another on the current collector layer, where N is an integer greater than one; and pressing the N strips of lithium metal against the rolling surface to create a laminated lithium metal anode layer on the current collector layer.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a lithium metal anodes for battery cells.

Electric vehicles such as hybrid vehicles and battery electric vehicles include a battery pack including one or more battery modules including a plurality of battery cells. The battery cells include electrodes (such as anode electrodes and cathode electrodes) and separators.

### SUMMARY

A method for manufacturing an anode electrode includes providing a current collector layer on a rolling surface; arranging N strips of lithium metal parallel to one another on the current collector layer, where N is an integer greater than one; and pressing the N strips of lithium metal against the rolling surface to create a laminated lithium metal anode layer on the current collector layer.

In other features, the method includes pressing the N strips of lithium metal is performed by a roller. Pressing the N strips of lithium metal is performed by N rollers. A first one of the N strips of lithium metal is laminated by a first one of the N rollers, a second one of the N strips of lithium metal is laminated by a second one of the N rollers, and an Nth one of the N strips of lithium metal is laminated by an Nth one of the N rollers.

In other features, the method include applying a first coating on the current collector layer and a second coating on the current collector layer parallel to and spaced from the first coating, wherein the N strips of lithium metal are laminated to the current collector layer between the first coating and the second coating. The first coating and the second coating comprise a polymer coating.

In other features, the roller includes a first cylindrical portion and a second cylindrical portion arranged at opposite axial ends of the roller; and the first cylindrical portion and the second cylindrical portion have a diameter that is greater than a diameter of a cylindrical body of the roller. The first cylindrical portion and the second cylindrical portion are made of a material that is softer than a material used for the cylindrical body of the roller.

In other features, the roller includes a first cylindrical knife and a second cylindrical knife arranged at opposite axial ends of the roller. The first cylindrical knife and the second cylindrical knife have a diameter that is in a range from 80% to 120% of a diameter of a cylindrical body of the roller. The diameter of the first cylindrical knife and the second cylindrical knife is greater than the diameter of the cylindrical body of the roller by 80% to 120% of a thickness of the laminated lithium metal anode layer. The first cylindrical knife and the second cylindrical knife cut opposite sides of the laminated lithium metal anode layer without cutting the current collector layer.

In other features, the roller includes (N−1) cylindrical portions aligned with (N−1) interface portions of the N strips of lithium metal. The (N−1) cylindrical portions are made of a material that is softer than a material used for a cylindrical body of the roller. The method includes applying a lithium bond promoting coating on the current collector layer in a predetermined area where bonding of the N strips of lithium metal is desired. The lithium bond promoting coating comprises a carbon coating. The current collector layer comprises copper foil.

A method for manufacturing an anode electrode includes providing a current collector layer on a rolling surface; arranging N strips of lithium metal parallel to one another on the current collector layer, where N is an integer greater than one; and using a roller, pressing the N strips of lithium metal against the rolling surface to create a laminated lithium metal anode layer on the current collector layer. The roller includes a first cylindrical portion and a second cylindrical portion arranged at opposite axial ends of the roller. The first cylindrical portion and the second cylindrical portion have a diameter that is greater than a diameter of a cylindrical body of the roller.

In other features, the first cylindrical portion and the second cylindrical portion are made of a material that is softer than a material used for the cylindrical body of the roller.

A method for manufacturing an anode electrode comprises providing a current collector layer on a rolling surface; arranging N strips of lithium metal parallel to one another on the current collector layer, where N is an integer greater than one; and using a roller, pressing the N strips of lithium metal against the rolling surface to create a laminated lithium metal anode layer on the current collector layer having an increased width. The roller includes (N−1) cylindrical portions aligned with (N−1) interface portions of the N strips of lithium metal.

In other features, the (N−1) cylindrical portions are made of a material that is softer than a material used for a cylindrical body of the roller.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a plan view of an example of a roller pressing multiple strips of a lithium metal layer onto a current collector layer to create a wider laminated lithium metal anode layer according to the present disclosure;

FIG. 2 is a perspective view of an example of a roller pressing multiple strips of the lithium metal layer onto a current collector layer to create a wider laminated lithium metal anode layer according to the present disclosure;

FIG. 3 is a perspective view of an example of a plurality of rollers pressing multiple strips of the lithium metal layer onto a current collector layer according to the present disclosure;

FIG. 4A is a perspective view of an example of a roller pressing multiple strips of the lithium metal layer onto a current collector layer between coating layers according to the present disclosure;

FIG. 4B is a perspective view of an example of a roller pressing multiple strips of the lithium metal layer onto a bond promoting coating located on a current collector layer according to the present disclosure;

FIG. 5 is a perspective view of an example of a roller with knives located at opposite axial ends to press multiple strips of the lithium metal layer onto a current collector layer while kiss cutting outer edges according to the present disclosure;

FIGS. 6A to 6C are perspective views of examples of rollers with raised cylindrical portions at opposite axial ends to press the multiple strips of the lithium metal layer onto a current collector layer according to the present disclosure;

FIG. 7A is a perspective view of an example of a roller including raised cylindrical portions located at interface regions of multiple strips of the lithium metal layer according to the present disclosure;

FIGS. 7B and 7C are side views of examples of rollers including raised cylindrical portions at interface regions of multiple strips of the lithium metal layer according to the present disclosure; and

FIG. 7D is a side view of the multiple strips of a lithium metal layer and interface regions between the multiple strips of the lithium metal layer according to the present disclosure.

In the drawings, reference numbers may be reused to identify similar and/or identical elements.

### DETAILED DESCRIPTION

While anode electrodes including lithium metal anodes and current collector layers for battery cells are described below in the context of electric vehicles, the anode electrodes described herein can be used in battery cells for stationary applications or other applications.

Battery cells typically include anode electrodes, cathode electrodes and separators. Battery cells including lithium metal anodes have high specific capacity and low density. The anode electrodes include lithium metal anode layers that are attached or laminated to one or both sides of an anode current collector layer (e.g., copper foil or another material). In some examples, the strips of the lithium metal anode layer and the current collector layer are made of foil.

Commercially available ultra-thin lithium foil (e.g., less than 50 μm thick) is limited to 150 mm in width due to process and/or handling issues. However, large format pouch cells require the lithium metal anodes to have a width in a range from 550-600 mm which requires wider lithium foil than is currently available.

The present disclosure relates to a method for laminating multiple strips of lithium foil in parallel onto a current collector layer to provide wider laminated lithium metal anode layers (e.g., widths greater than 150 mm). In some examples, the method for manufacturing the lithium metal anode layers according to the present disclosure also controls spreading of outer edges of the laminated lithium metal anode layer using coatings applied to the current collector layer. The coatings can be removed from the current collector layer after pressing is performed.

In other examples, the roller includes cylindrical portions located at ends thereof that define shoulders to limit spreading of the lithium metal layer during pressing. In some examples, the method for manufacturing the laminated lithium metal anode layers uses a roller including cylindrical portions aligned with interface regions of the strips of lithium metal to blend the interface regions.

In some examples, multiple strips of lithium foil are arranged in parallel with a predetermined stack-up or overlap. In some examples, a bond promoting coating is applied to the current collector layer in a predetermined areas to promote bonding of the strips of lithium metal in the predetermined area (and facilitate removal of the lithium foil outside of the predetermined area).

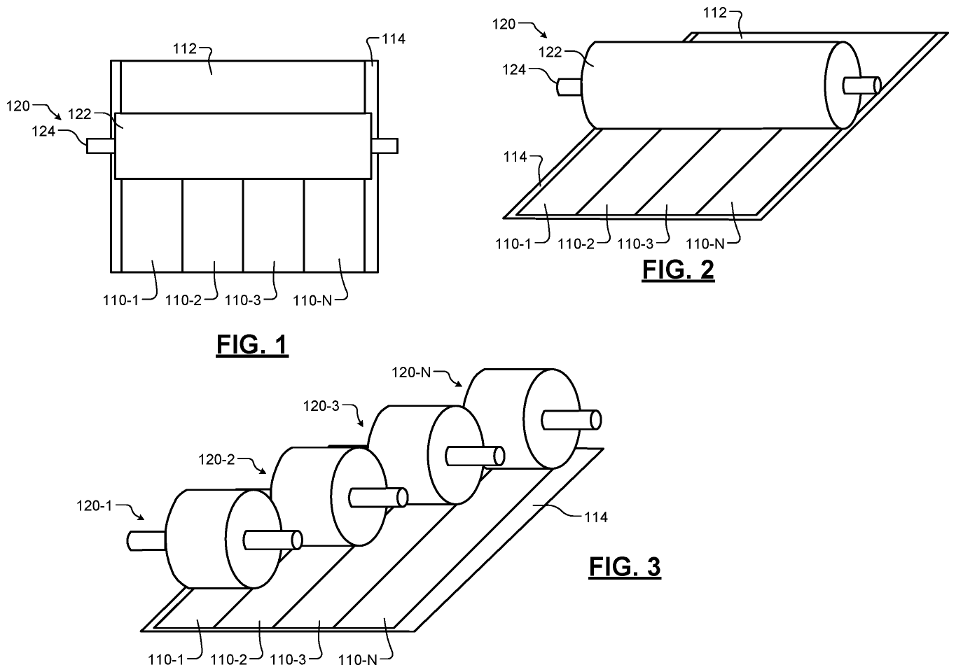

Referring now to FIGS. 1 to 3, N strips of lithium metal 110-1, 110-2, . . . , and 110-N are arranged with edges thereof aligned with adjacent ones of the N strips of lithium metal 110, where N is an integer greater than one. While a single roller is used to press the N strips of lithium metal in FIGS. 1 and 2, a plurality of rollers are used in FIG. 3. In some examples, the N strips of lithium metal 110 comprise lithium foil having a thickness less than 50 μm and a width less than 150 mm.

In FIGS. 1 and 2, a roller 120 includes a cylindrical body 122 and a shaft 124. The roller 120 presses the N strips of lithium metal 110 against a current collector layer 114 supported on a rolling surface such as another roller or a flat surface. A laminated lithium metal anode layer 112 that is produced by pressing is wider than an individual strip of the lithium metal. In some examples, the laminated lithium metal anode layer 112 is approximately N times a width of the strip of lithium metal 110 less overlap and/or material removed by trimming.

In FIG. 3, a plurality of rollers 120-1, 120-2, . . . , and 120-N can be used instead of a single roller. In some examples, a first one of the N strips of lithium metal is pressed by a first one of the rollers 120-1, 120-2, . . . , and 120-N onto the current collector layer 114. A second one of the N strips of lithium metal is pressed by a second one of the rollers 120-1, 120-2, . . . , and 120-N onto the current collector layer 114. An Nth one of the N strips of lithium metal is pressed by an Nth one of the rollers 120-1, 120-2, . . . , and 120-N onto the current collector layer 114. Edges of the N strips of lithium metal are in contact and/or overlapping. As can be appreciated, while the N strips of lithium metal are pressed from one side to the other, the order of the pressing of the N strips of lithium metal can be varied.

In some examples, the current collector layer 114 has a width of 630 mm, each of the lithium metal strips 110 has a width of 150 mm, and N=4. In some examples, outermost ones of the lithium metal strips 110 are arranged with first and second gaps, respectively, relative to edges of the current collector layer 114. In some examples, the first gap is 5 mm and the second gap is 25 mm.

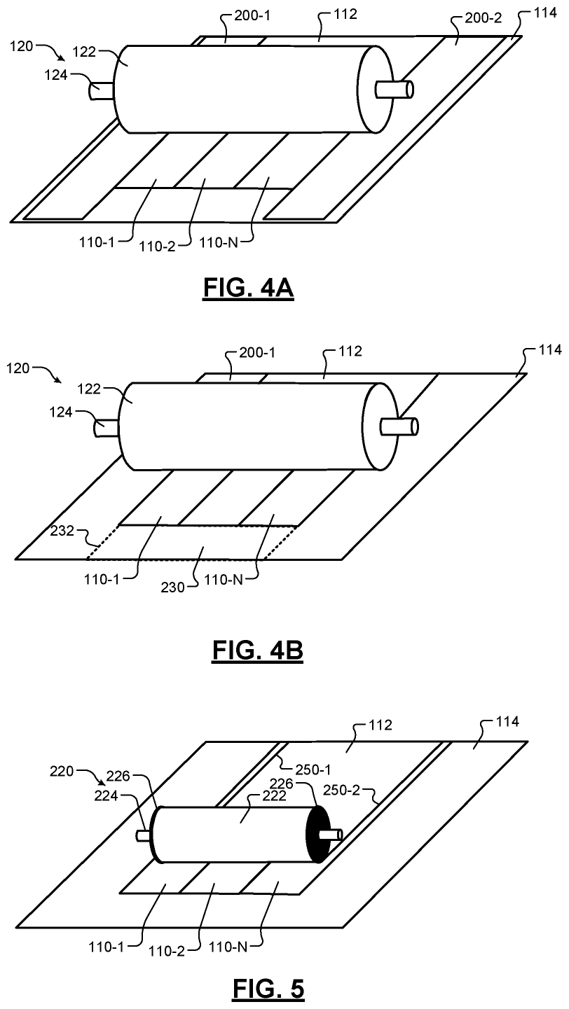

Referring now to FIG. 4, coatings 200-1 and 200-2 are applied to the current collector layer 114 before pressing to control spreading of the laminated lithium metal anode layer 112 during pressing. In some examples, the coatings 200-1 and 200-1 comprise a polymer layer (e.g., polyimide). In some examples, opposite edges of the roller 120 rest on the coatings 200-1 and 200-2 during lamination. The coatings 200-1 and 200-2 act as an edge stop to prevent spreading of the laminated lithium metal anode layer 112 during pressing. After pressing, the coating can be removed (e.g., using a solvent such as acetone).

In some examples, the coatings 200-1 and 200-2 comprise a bond limiting coating that limits the bonding of the lithium metal foil to the current collector layer 114 to allow removal of the lithium metal foil outside of inner edges of the coatings 200-1 and 200-2. In some examples, the bond limiting coating comprises poly (methyl methacrylate) (PMMA) or oil to enable removal of the lithium foil on the bond limiting coating. After pressing, the coatings 200-1 and 200-2 are removed using solvent.

In FIG. 4B, the current collector layer 114 includes a lithium bond promoting coating 230 arranged in a predetermined area 232 where the laminated lithium metal anode layer 112 is desired. The lithium bond promoting coating 230 comprises a material that facilitates lithium bonding in the predetermined area 232 and allows the lithium metal foil to easily be removed outside of the predetermined area 232. In some examples, the lithium bond promoting coating 230 comprises a carbon coating.

Referring now to FIG. 5, a roller 220 includes a cylindrical body 222 and a shaft 224. Circular knives 226 are arranged at opposite axial ends of the roller 220. The circular knives 226 extend radially outwardly from the cylindrical body 222 by a predetermined distance. In some examples, the predetermined distance is within 80% to 120% of the thickness of the lithium metal strips. The circular knives 226 cut the laminated lithium metal anode layer 112 to control the width of the laminated lithium metal anode layer. In some examples, the circular knives 226 kiss cut the laminated lithium metal anode layer 112 without cutting through the current collector layer 114 arranged below.

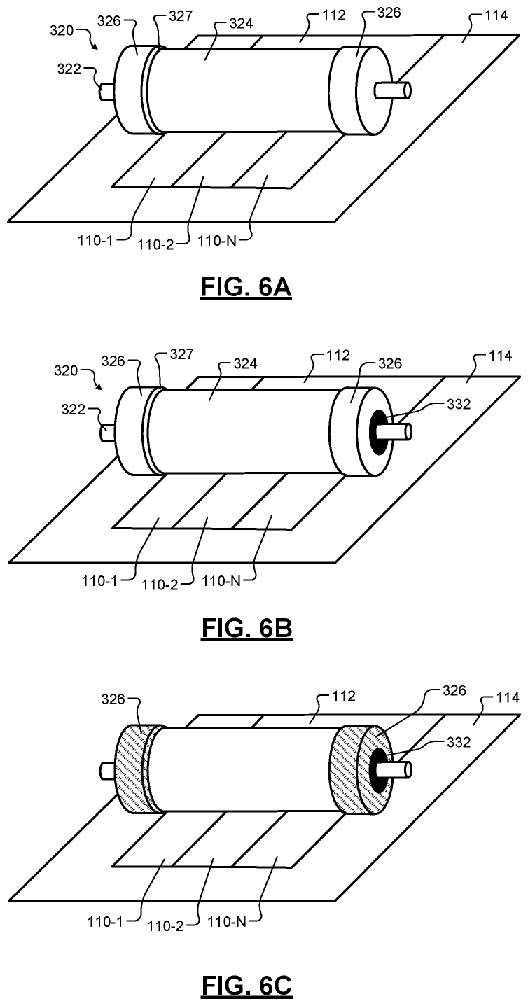

Referring now to FIGS. 6A to 6C, a roller 320 includes a cylindrical body 324 and a shaft 322. Cylindrical portions 326 are located at ends of the cylindrical body 324. The cylindrical portions 326 have a larger diameter than the cylindrical body 324. For example, the cylindrical portions 326 have a radius that is larger than the cylindrical body 324 by 80% to 120% of the thickness of the laminated lithium metal anode layer 112. The cylindrical portions 326 define a shoulder 327 relative to the cylindrical body 324. The shoulder 327 limits spreading of the laminated lithium metal anode layer 112 during pressing.

In some examples, the cylindrical portions 326 located at the axial ends of the cylindrical body 324 include bearings 332 to allow the cylindrical portions 326 to roll independently from the cylindrical body 324. The cylindrical portions 326 spin while maintaining a predetermined gap (e.g., <5 μm) relative to the cylindrical body 324. In some examples, the cylindrical portions 326 are made of a different material than the cylindrical body 324. In some examples, the cylindrical portions 326 are made of a material that is softer than a material used for the cylindrical body 324.

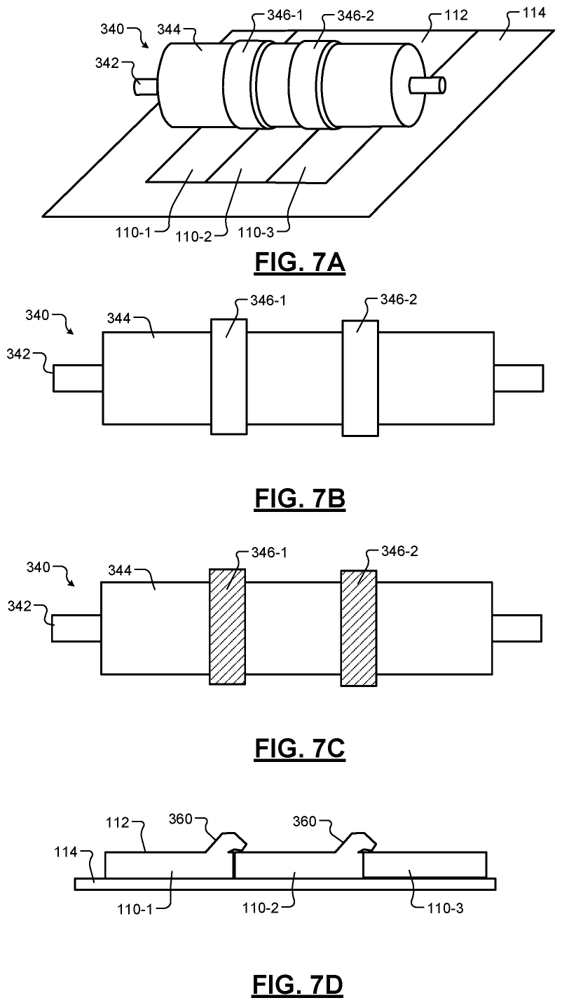

Referring now to FIGS. 7A to 7D, a roller 340 includes a cylindrical body 344 and a shaft 342. In FIGS. 7A to 7C, (N−1) cylindrical portions 346 are located between axial ends of the roller 340 and aligned with (N−1) interface regions 360 (shown in FIG. 7D) located between adjacent ones of the N strips of lithium metal 110. The (N−1) cylindrical portions 346 have a larger diameter than the cylindrical body 324.

The (N−1) cylindrical portions 346 can be designed to enhance the quality of the (N−1) interface regions 360. The (N−1) cylindrical portions 346 add pressure to the (N−1) interface regions 360 to smooth the (N−1) interface regions 360 and to improve lamination quality. In some examples, the (N−1) cylindrical portions 346 are made of a different material than the cylindrical body 344. In some examples, the (N−1) cylindrical portions 346 are made of a material that is softer than a material used for the cylindrical body 344.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing an anode electrode, comprising:
providing a current collector layer on a rolling surface;
arranging N strips of lithium metal parallel to one another on the current collector layer, where N is an integer greater than one; and
pressing the N strips of lithium metal against the rolling surface to create a laminated lithium metal anode layer on the current collector layer.

2. The method of claim 1, wherein pressing the N strips of lithium metal is performed by a roller.

3. The method of claim 1, wherein pressing the N strips of lithium metal is performed by N rollers.

4. The method of claim 3, wherein:
a first one of the N strips of lithium metal is laminated by a first one of the N rollers,
a second one of the N strips of lithium metal is laminated by a second one of the N rollers, and
an N^{th} one of the N strips of lithium metal is laminated by an Nth one of the N rollers.

5. The method of claim 1, further comprising applying a first coating on the current collector layer and a second coating on the current collector layer parallel to and spaced from the first coating, wherein the N strips of lithium metal are laminated to the current collector layer between the first coating and the second coating.

6. The method of claim 5, wherein the first coating and the second coating comprise a polymer coating.

7. The method of claim 2, wherein:
the roller includes a first cylindrical portion and a second cylindrical portion arranged at opposite axial ends of the roller; and
the first cylindrical portion and the second cylindrical portion have a diameter that is greater than a diameter of a cylindrical body of the roller.

8. The method of claim 7, wherein the first cylindrical portion and the second cylindrical portion are made of a material that is softer than a material used for the cylindrical body of the roller.

9. The method of claim 2, wherein:
the roller includes a first cylindrical knife and a second cylindrical knife arranged at opposite axial ends of the roller; and
the first cylindrical knife and the second cylindrical knife have a diameter that is in a range from 80% to 120% of a diameter of a cylindrical body of the roller.

10. The method of claim 9, wherein the diameter of the first cylindrical knife and the second cylindrical knife is greater than the diameter of the cylindrical body of the roller by 80% to 120% of a thickness of the laminated lithium metal anode layer.

11. The method of claim 9, wherein the first cylindrical knife and the second cylindrical knife cut opposite sides of the laminated lithium metal anode layer without cutting the current collector layer.

12. The method of claim 2, wherein the roller includes (N−1) cylindrical portions aligned with (N−1) interface portions of the N strips of lithium metal.

13. The method of claim 12 wherein the (N−1) cylindrical portions are made of a material that is softer than a material used for a cylindrical body of the roller.

14. The method of claim 1, further comprising applying a lithium bond promoting coating on the current collector layer in a predetermined area where bonding of the N strips of lithium metal is desired.

15. The method of claim 14, wherein the lithium bond promoting coating comprises a carbon coating.

16. The method of claim 1, wherein the current collector layer comprises copper foil.

17. A method for manufacturing an anode electrode comprising:
providing a current collector layer on a rolling surface;
arranging N strips of lithium metal parallel to one another on the current collector layer, where N is an integer greater than one; and
using a roller, pressing the N strips of lithium metal against the rolling surface to create a laminated lithium metal anode layer on the current collector layer,
wherein the roller includes a first cylindrical portion and a second cylindrical portion arranged at opposite axial ends of the roller, and
wherein the first cylindrical portion and the second cylindrical portion have a diameter that is greater than a diameter of a cylindrical body of the roller.

18. The method of claim 17, wherein the first cylindrical portion and the second cylindrical portion are made of a material that is softer than a material used for the cylindrical body of the roller.

19. A method for manufacturing an anode electrode comprising:
providing a current collector layer on a rolling surface;
arranging N strips of lithium metal parallel to one another on the current collector layer, where N is an integer greater than one; and
using a roller, pressing the N strips of lithium metal against the rolling surface to create a laminated lithium metal anode layer on the current collector layer having an increased width,
wherein the roller includes (N−1) cylindrical portions aligned with (N−1) interface portions of the N strips of lithium metal.

20. The method of claim 19, wherein the (N−1) cylindrical portions are made of a material that is softer than a material used for a cylindrical body of the roller.
